(19) United States
(12) Patent Application Publication
(10) Pub. No.: US 2026/0302771 A1
(43) Pub. Date: Oct. 1, 2026

(54) DUAL-PURPOSE POWERING DEVICE

(71) Applicant: Lenovo (United States) Inc., Morrisville, NC (US)

(72) Inventor: Omar Ali, Cary, NC (US)

(21) Appl. No.: 19/094,063

(22) Filed: Mar. 28, 2025

(51) Int. Cl. H02J 1/10; H02J 1/14; H02J 7/34

(52) U.S. Cl. CPC H02J 1/106; H02J 1/14; H02J 7/34

(57) ABSTRACT

One embodiment provides a device, including: a system; a backplane connected to the system, wherein the backplane includes electrical connections for at least two power supply units; and at least two power supply units electrically connected to the backplane via the electrical connections, wherein one of the at least two power supply units includes a power supply unit and wherein another of the at least two power supply units includes a battery backup unit. Other aspects are claimed and described.

### BACKGROUND

All systems (e.g., information handling device, storage device, processors, etc.) require a power source to operate. The power source can be a stationary power source that utilizes a wired connection (e.g., plugging into an A/C power supply, etc.) and/or a mobile power source (e.g., traditional batteries, rechargeable power source, a power bank, etc.). No matter the type of power source, enough charge must be supplied from the power source to the system in order to utilize the system. An amount of power required to operate a system may vary. Additionally, a system can include one or more operating modes that can be utilized based on an amount of power available to a system from a power source (e.g., a full-power mode, a low-power mode, etc.).

### BRIEF SUMMARY

In summary, one aspect provides a system, including: a backplane connected to the system, wherein the backplane includes electrical connections for at least two power supply units; and at least two power supply units electrically connected to the backplane via the electrical connections, wherein one of the at least two power supply units includes a power supply unit and wherein another of the at least two power supply units includes a battery backup unit.

Another aspect provides a system, including: a backplane connected to the system, wherein the backplane includes electrical connections for at least two power supply units; and at least two power supply units electrically connected to the backplane via the electrical connections, wherein one of the at least two power supply units includes a power supply unit and wherein another of the at least two power supply units includes a battery backup unit, wherein at least one of the at least two power supply units provides power to the system via the backplane at a time; and wherein a power demand of the system is greater than a power output of the power supply unit.

A further aspect provides a method, comprising: detecting, at a system comprising a backplane and at least two power supply units electrically connected to the backplane, an increase in power consumption by the system, wherein at least one of the at least two power supply units comprises a power supply unit and wherein at least another of the at least two power supply units comprises a battery backup unit; determining that a maximum power output of the power supply unit cannot fulfill the increase in power consumption by the system; and receiving power output from the battery backup unit in addition to the power output of the power supply unit, wherein the power output from the battery backup unit and the power output of the power supply unit fulfill the increase in power consumption by the system.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example dual-purpose powering device system setup.

FIG. 4 illustrates an example device including a battery backup unit.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A majority of electronic systems utilize a single power supply. A single power supply may provide enough power to a system in order for the system to operate at a high-level. For a device that requires a lower amount of power to operate, for example, a mobile device, a power supply may may be presented in the form of a battery. A battery contains a finite amount of power that can be supplied to a system, and is seen as a lower amount of power. This is because a maximum level of power that can be provided from the battery to the system is present upon initial connection, and then a battery will continuously lose power until the battery in depleted. In one system, a battery in use can be a disposable battery that is thrown out once the charge has been used. In an alternative system, a battery can be a rechargeable battery that may receive power from an alternate source than the system to revamp its charge. Batteries commonly lack the ability to power systems that require a high amount of power to operate, for example, a kitchen appliance, a television, a space-heater, and/or the like. What a system powered by a battery lacks in operative ability is made up with mobile convenience. Rather than being restricted to a single location, a battery powered system is more easily mobile.

As for a system that requires a greater amount of power to operate (in comparison to a battery operating system), the system will receive power from a source via a wired connection to a power source. For example, a power source may be the alternating current supplied to a home via an electric grid of a city, where connection to the source requires the plugging-in of a wired connection to an outlet that is connected to a system. Then, because the power source is being continuously provided, there is not a finite amount of charge that can be supplied to the system, as is described above for a device that requires a lower amount of power to operate. However, there is a maximum amount of power that can be supplied to a system based upon the type of connection and/or output of an outlet/connection means. For example, the most common output charge via an outlet in a home is 120v. Therefore, the maximum threshold power level of source is 120v, which is commonly enough for most devices. Additionally, and/or alternatively, in an example system, a house may include a 240v plug for much larger appliances (e.g., clothes dryer, water heater, oven, etc.).

As technology moves forward, some systems can include two power sources. This inclusion of two power sources is commonly a power source that provides enough power for a system to operate and a much smaller power source that can keep some internal components in operation while a device is in a mechanical-off state. For example, a personal computer may require a connection to a power source with a greater amount of power (e.g., plugging into a 120v outlet in a home) while also including a coin battery on a motherboard that is located internally of the system. The charge received from a greater power source will make the PC operable, and then when the PC is shutdown, the coin battery will supply small internal components with a charge to keep them active, for example, a clock present within a chipset of a device that tracks the time to ascertain accuracy when the PC is powered on. This combination of power sources present at a device is becoming more routine, but fails to be utilized in such a way that may account for system powering issues that can arise. For example, if a power surge and/or a blackout occurs, the coin battery of the PC cannot provide enough power to keep the device operable, even for a short period of time. Additionally, and/or alternatively, for example, if a PC is attempting to utilize an application that requires more power than a 120v source can provide, the coin battery of the PC cannot overcome the deficiency of the power source; therefore, the application cannot be used. What is needed is a system that can receive power from multiple connected power sources that can supply an additional amount of power to the system in response to a power issue.

Accordingly, the described system provides a dual-purpose powering device that includes the use of at least two power supply units to account for and overcome unforeseen system powering issues. A system that may utilize the dual-purpose powering device includes, but is not limited to, an information handling device, a storage device, a computing device (e.g., server, processor, network, etc.), and/or a power consumption device (e.g., generator, HVAC unit, etc.). A backplane that includes at least two power supply input areas may be coupled to a device, which may then accept a combination of standard power supply units and battery backup units. In the system, the backplane coupled to the device may be integrally coupled to the device and/or may be coupled to a device via a single power supply input area that is present at the system. Then, in the system, based upon the backplane design, each system may include a standard power supply unit and at least one battery backup unit.

In the system, a standard power supply unit describes a traditional power supply that may power a device. The standard power supply unit may vary based upon a device (e.g., a battery for powering a smartphone, a PC that requires a 120v connection, etc.). The standard power supply unit describes how the device may operate without the addition of at least one battery backup unit to the device. A battery backup unit is a secondary power supply unit; therefore, the battery backup unit will not be activated until needed, for example, in response to a system powering issue and/or when additional amount of power is required by a device. In the system, the device may operate in one of at least two separate power modes to supply an additional amount of power to the device. In the system, the device may operate in a shared-power mode which may utilize power supplied from both of the standard power supply unit and the at least one battery backup unit simultaneously. The shared-power mode may utilize power from the at least one battery backup unit to overcome a deficiency of a standard power supply unit when an application present on a device requires more power to operate than can be supplied from the standard power supply unit alone. Additionally, and/or alternatively, in the system, a device may operate in a redundant-power mode which may utilize power supplied from a battery backup unit in response to a sudden disconnection of power from a standard power supply unit to the device, for example, a city-wide power outage. The redundant-power mode may provide a device with an ability to perform a graceful shutdown in response to a system powering issue. Therefore, rather than accepting an undesired result when a system power issue arises, the dual-purpose powering device supports a system in an environment of uncertainty.

The illustrated example embodiments will be best understood by reference to the figures. The following description is intended only by way of example, and simply illustrates certain example embodiments.

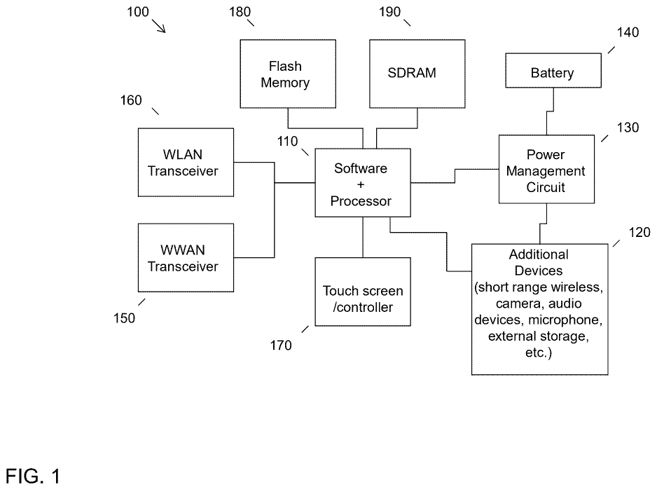

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

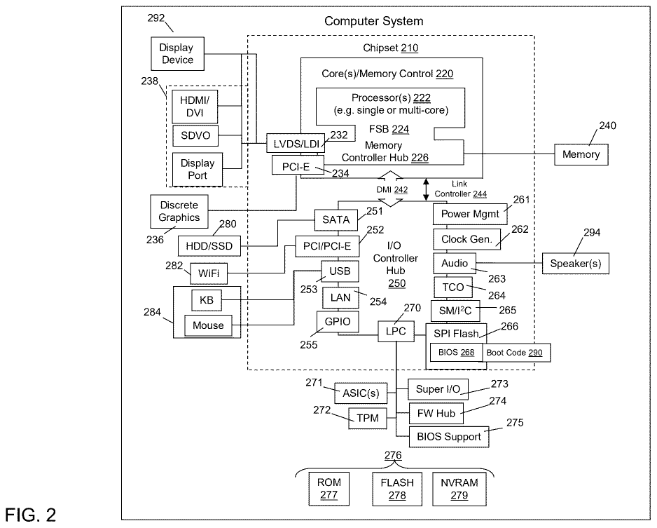

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems associated with servers and networks to which servers may be added or provisioned and devices or systems that may assist in providing an additional amount of power from a secondary source in response to a power supply issue present at a system. For example, the circuitry outlined in FIG. 1 may be implemented in a tablet or smart phone embodiment, whereas the circuitry outlined in FIG. 2 may be implemented in a personal computer embodiment.

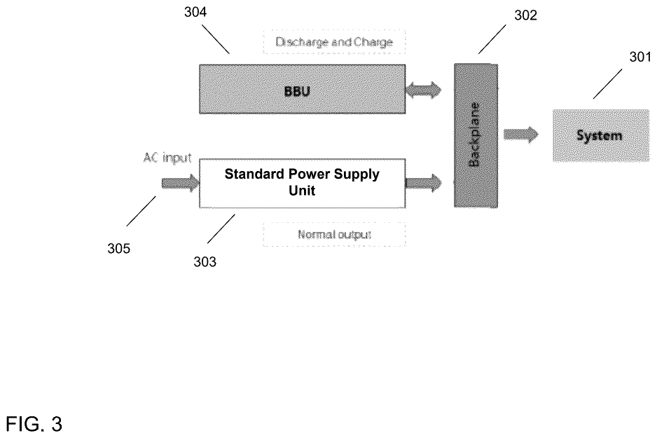

FIG. 3 illustrates an example dual-purpose powering device system setup. The device may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to overcome the deficiencies of a standard power supply unit in response to present system powering issue. Additionally, the dual-purpose power device includes modules and features that are unique to the described system.

At 301, a system that receives power from a dual-purpose powering device is present. A system may be any device type that requires a power supply in order to operate, for example, an information handling device, a storage device, a computing device (e.g., server, processor, network, etc.), and/or a power consumption device (e.g., generator, HVAC unit, etc.). Providing such a system with power will present a user with an operable system that may perform a desired function. Throughout this disclosure reference to an information handling device may be made, but this is intended as a non-limiting example. A dual-purpose power device may be utilized with a plurality of systems, all which require electrical power to operate.

The dual-purpose powering device of FIG. 3 then presents a backplane 302 coupled to the system 301. A backplane 302 acts as a connection point between components of a device and/or system. The backplane 302 may be operatively coupled to an information handling device that traditionally includes a single power supply unit. Coupling a backplane 302 to a system 301, and/or the information handling device, may provide the system with an additional power supply input area that may accept an additional power supply unit at the system. A backplane 302 may be operatively coupled to the system via connection through a single power supply input area on the system 301, and/or information handling device, for example, at a power cord input location. The backplate 302 may then include at least two power supply input areas containing connection components on an opposite side of the backplane 302 permitting the acceptance of additional power supplies at the system 301. Additionally, and/or alternatively, a backplane 302 may be integrally coupled to the system 301 presenting at least two power supply input areas directly into the system 301.

The at least two power supply input areas present on the backplane 302 that may accept a power supply unit may include at least one of a male connection component and a female connection component. As is traditionally understood, a male connection component may be consumed by a female connection component present at a power supply unit. Alternatively, as is traditionally understood, a female connection component may receive a male connection component preset at a power supply unit. The connection component at a power supply input area on the backplane 302 and the connection component present at a power supply unit complete an appropriate coupling of connection components and permits the use of a power supply units 303 and 304 at the dual-purpose powering device of the system 301. The at least two input areas on the backplane 302 may both include female connection components; therefore, the connection components of the power supply units 303 and 304 will be male connection components. Additionally, and/or alternatively, the connection component types may be a combination of male connection components and female connection components.

Connection of a power supply unit at a power supply input area of the backplane 302 includes the connection of a standard power supply unit 303. A standard power supply unit 303 describes a traditional power supply unit utilized by the system 301. The standard power supply unit 303 is connected through the backplane 302 to power the system 301. Additionally, the system 301 may utilize a standard power supply unit 303 that accepts power from an external power source 305. In the system, the external power source 305 may be, for example, power provided by an electric grid directly to a user's home, office, and/or the like, supplied via a 120v outlet. A standard power supply unit 303 may accept the power from the external power source 305 to then power the system 301. The standard power supply unit 303 may regulate the power received from the external power source 305 to assure that no damage to the system 301 occurs. The standard power supply unit 303 provides a baseline amount of power from the external power source 305 to the system 301. A baseline amount of power supplied through the standard power supply unit 303 and the backplane 302 to the system 301 is the required amount of power needed for the system 301 to operate in a traditional manner. Additionally, because the standard power supply unit 303 accepts and monitors an amount of power received from an external power source 305, a baseline amount of power operates below a maximum threshold power level of the standard power supply unit 303. In other words, rather than the system 301 operating at a maximum threshold power level that can damage the system, the standard power supply unit 303 provides an acceptable, and non-lethal, amount of power to the system 301 through the backplane 302. Additionally, and/or alternatively, backplane 302 may assist with controlling an amount of charge directed to the system 301 further protecting a system 301 from damage, for example, overcharging, overheating, shorting of system components, and/or the like.

The backplane 302 including at least one additional power supply input area may then accept a secondary power supply unit, and/or a battery backup unit 304. A battery backup unit 304 is a power supply unit that is coupled to the backplane 302 in support of the standard power supply unit 303 and may provide an additional amount of power to the system 301 when a system power issue arises. A battery backup unit 304 is a power supply unit that supplies a lesser amount of power than the standard power supply unit 303 to the system 301. As mentioned previously, a mobile power supply unit, and/or a battery, contains a finite amount of power depending on the size of the battery. Unlike a standard power supply unit 303 that is continuously receiving a charge, for example, an alternating current, from an external source 305, a battery backup unit 304 connected to a backplane 302 is connected in anticipation of supporting, and/or assisting, a standard power supply unit 303 in response to a system powering issue. An additional amount of power supplied from the battery backup unit 304 may be in response to a determined lack of power being supplied from the standard power supply unit 303. For example, in response to a blackout that cuts off the power to the external source 305 and therefore the standard power supply unit 303, a battery backup unit 304 may supply enough power to the system 301 to permit a graceful shutdown. Additionally, and/or alternatively, for example, in response to determining that a standard power supply unit 303 cannot provide enough power to the system 301 to utilize an application present on a device, a battery backup unit 304 may work in combination with the standard power supply unit 303 and supply the system 301 with the necessary additional amount of power in order to utilize the application of the device. When the battery backup unit 304 is being used in combination with the standard power supply unit 303, the power input to the system 301 increases beyond the maximum threshold power level of the standard power supply unit 303. In other words, the maximum threshold power level of the at least two power supply units is greater than the maximum threshold power level of the standard power supply unit 303.

The presence of a standard power supply unit 303 and a battery backup unit 304 connected through a backplane 302 to a system 301 requires at least one of the power supply units to be in operation at all times. As will be described herein, power supply unit orientation at a system may adjust in response to an amount of charge required to power the system 301; however, if it important to understand that while a system 301 is in operation at least one power supply unit will remain active in support of powering the system 301. Additionally, upon the connection of at least one battery backup unit 304 to a system 301 that already includes a standard power supply unit 303, a power bank and/or battery of the battery backup unit 304 may be recharged by the power being supplied to the system by the standard power supply unit 303. When a battery backup unit 304 is not required at an instance for providing additional power to a system, a battery backup unit 304 may recharge until reaching a maximum charge level.

In the system, the at least two power supply units 303 and 304 of the dual-purpose powering device system may operate in a shared-power mode. A shared-power mode describes a combination orientation of the at least two power supply units 303 and 304 for powering a device when a baseline amount of power supplied from the standard power supply unit 303 is not enough. In other words, a shared-power mode increases the maximum threshold power level of a system based upon the at least two power supply units present in the system. A shared-power mode may be utilized when an application of a device requires more power for operation than can be provided by the standard power supply unit 303 alone. As mentioned previously, in order to assure that damage to the system 301 does not occur by operating the standard power supply unit 303 at a maximum threshold power level, an addition of a battery backup unit 304 to the system 301 that is connected through the backplane 302 will increase a maximum threshold power level for the overall system. When operating in a shared-power mode, and upon determining that the baseline power supplied from the standard power supply unit 303 is not enough to operate an application present on an information handling device, the system may further determine a deficit between the maximum threshold power level of the standard power supply unit 303 and the required power level of the application, and draw this amount of power from the battery backup unit 304 to overcome the deficit; thus, permitting utilization of the application.

In the system operating in a shared-power mode, a battery backup unit 304 having a finite amount of power present therein may be used in combination with the standard power supply unit 303 for a determined time period. For example, the dual-purpose powering device may determine that the battery backup unit 304 may support the utilization of an application for a window of time based upon how much charge is available within the battery backup unit 304. A backplane 302 includes at least one battery backup unit 304; therefore, embodiments of the dual-purpose device may exist that include two or more battery backup units 304 coupled to the backplane 302 in addition to the standard power supply unit 303. A maximum threshold power level of the system increases with each battery backup unit 304 coupled to the backplane 302. In other words, as long as a backplane 302 includes available power supply input areas, multiple battery backup units 304 may be coupled to the backplane 302. Then, as a maximum threshold power level increases with each battery backup unit 304 coupled to the backplane 302, a time period for utilizing an application that requires a power level beyond what can be supplied by the standard power supply unit 303 also increases.

Additionally, and/or alternatively, in the system operating in a shared-power mode, a standard power supply unit 303 and a battery backup unit 304 may operate in parallel. Operating in parallel describes drawing a same amount of power from the standard power supply unit 303 and a battery backup unit 304 simultaneously, and/or independently drawing an amount of power from at least one of the power supply units. A system may prefer operating with a parallel charge approach in order to utilize the power reserve of a battery backup unit 304, decrease an amount of power needed from a standard power supply unit 303, and/or the like. A battery backup system may contain ions that may decrease over time, particularly when not utilized. Thus, in order to assure that a battery backup unit 304 maintains a high-level of operation, the system may elect to increase an amount of power to be drawn from the battery backup unit 304. Additionally, in the system operating in a shared-power mode that is further operating each power supply in parallel with one another, decreasing an amount of power being collected from external power supply 305 through a standard power supply unit 303 may decrease a cost of operating the system, for example, reducing a cost of an electrical utility.

As discussed previously, at least one battery backup unit 304 may be utilized by a dual-purpose power device when an additional amount of power is needed to operate the system. In a shared-power mode, an additional amount of power from a battery backup unit 304 may be utilized in addition to the power being supplied from a standard power supply unit 303. Additionally, and/or alternatively, an additional amount of power from a battery backup unit 304 to a system 301 may be supplied in response to a system power issue. In the system, the at least two power supply units 303 and 304 of a dual-purpose powering device may operate in a redundant-power mode. At least one battery backup unit 304 may act as a fail-safe for the system 301 when a system powering issue is present. A system powering issue includes restriction and/or removal of the external power 305 through the standard power supply unit 303 to the system 301, for example, during a blackout, a removal of a standard power supply unit connection (e.g., unplugging of a device), power surges, and/or the like. In other words, a system powering issue causes a loss of power at the standard power supply unit 303 and therefore, a loss of power at system 301. Traditionally, a system powering issue will cause the system 301 to abruptly shut down, potentially losing any unsaved information/data present at the system. For example, if a PC loses power while working on an unsaved document, the unsaved document may not be recoverable and the information/data is lost. In the system operating in a redundant-power mode, a battery backup unit 304 may become active in response to a system powering issue, and power the system for a period of time, avoiding an abrupt shutdown and potentially losing unsaved data.

In response to a system power issue occurring at the standard power supply unit 303, the at least two power supply units of the dual-purpose device operating in a redundant-power mode may supply the system 301 with power strictly from the battery backup unit 304. The battery backup unit 304 may supply enough power through the backplane 302 to the system 301 to promote a graceful shutdown. A graceful shutdown is an abbreviated time period for operating the system based upon an amount of power than can be provided from the battery backup unit 304 to the system 301 that permits the proper shutting down of a device including, for example, saving of unsaved data, closing of applications, signing off of a virtual meeting, and/or the like. Rather than abruptly shutting down a system, as is conventional when a system loses power through a standard power supply unit 303, a redundant-power mode allows a user to gradually shut down a device. Additionally, and/or alternatively, in the system operating in a redundant-power mode, at least one battery backup unit 304 may provide enough power to the system 301 to permit continuous work at the system 301. At least one battery backup device 304, and/or a combination of multiple battery backup devices 304 coupled to a backplane 302, may provide enough power to the system 301 to permit system usage while the standard power supply unit 303 is not available.

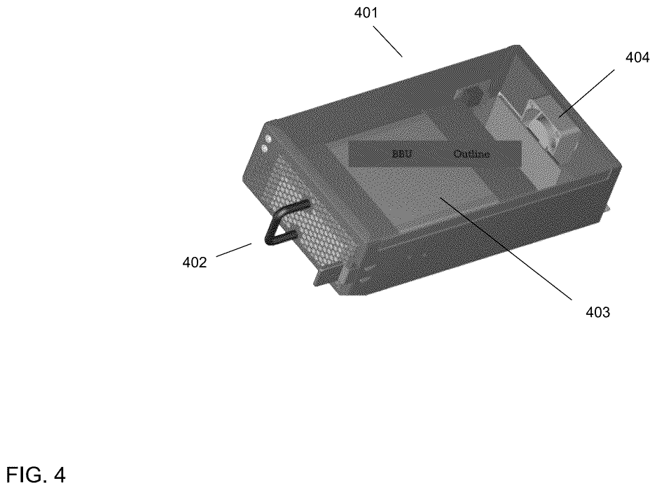

Referring now to FIG. 4, an illustration of an example battery backup unit is provided. A battery backup unit 401 comprises three primary components. A connection component 402 may couple the battery backup unit 401 to a backplane, see 302 of FIG. 3, of a system. In this figure, connection component 402 is represented at a male connection component that may then be paired with a female connection component present on a backplane of a device. Once again, this is intended as a non-limiting example, for a connection component 402 can also be a female connection component that can be paired with a male connection component present on the backplane coupled to a system, and/or information handling device. The connection component 402 stems from the battery pack 403 present within the battery backup unit 401. The battery pack 403 holds the charge of the battery backup unit 401. Its at this location that an amount of charge, and/or power, can be measured and shared with a system when an additional amount of power from the battery backup unit 401 is requested by the system. This request can be made while the dual-purpose powering device is operating in a shared-power mode or a redundant-power mode. The dual-purpose powering device may alternate operating modes in real-time and in response to a system power issue.

Since the battery pack 403 of the battery backup unit 401 may be utilized to support a standard power supply unit of an information handling device, a fan 404, and/or an opening for ventilation, of the battery backup unit 401 may be present at an opposite end of the battery backup unit 401 from the connection component 402. While in operation a temperature of a battery pack 403 may increase. A fan 404, and/or opening for ventilation, of the battery backup unit 401 may provide the battery backup unit with an ability to cool the battery pack 403 to ascertain that the battery backup unit 401 does not overheat. The fan 404 is located opposite the connection component 402 because the airflow around the connection component 402 when coupled to a backplane of a system will be minimal since it is a point of contact. In order for proper ventilation of the battery pack 403 to occur, airflow throughout the battery backup unit 401 must move easily and freely.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system, comprising:
a backplane connected to the system, wherein the backplane comprises electrical connections for at least two power supply units; and
at least two power supply units electrically connected to the backplane via the electrical connections, wherein one of the at least two power supply units comprises a power supply unit and wherein another of the at least two power supply units comprises a battery backup unit.

2. The system of claim 1, wherein the electrical connections are the same and wherein the battery backup unit comprises an electrical connector matching an electrical connector of the power supply unit.

3. The system of claim 1, wherein a power demand of the system is greater than a power output of the power supply unit.

4. The system of claim 3, wherein the at least two power supply units operate in a shared-power mode; and
wherein the power supply unit supplies a maximum amount of power output to the system and wherein the battery backup unit provides additional power to the system over the power output of the power supply unit to meet the power demand of the system.

5. The system of claim 1, wherein the at least two power supply units operate in a redundant-power mode; and
wherein the at least one battery backup unit in the redundant-power mode provides power to the system in an event of no power output by the power supply unit.

6. The system of claim 1, wherein the electrical connections are electrically connected to the backplane in parallel.

7. The system of claim 1, wherein the battery backup unit is charged from the system during a period of reduced power consumption by the system.

8. The system of claim 1, wherein the battery backup unit is not connected to an external power connection, wherein the power supply unit is connected to an external power connection.

9. The system of claim 1, wherein at least one of the at least two power supply units provides power to the system via the backplane at a time.

10. The system of claim 1, wherein the system is at least one of: an information handling device, a storage device, a computing device, and a power consumption device.

11. A system, comprising:
a backplane connected to the system, wherein the backplane comprises electrical connections for at least two power supply units; and
at least two power supply units electrically connected to the backplane via the electrical connections, wherein one of the at least two power supply units comprises a power supply unit and wherein another of the at least two power supply units comprises a battery backup unit, wherein at least one of the at least two power supply units provides power to the system via the backplane at a time; and
wherein a power demand of the system is greater than a power output of the power supply unit.

12. The system of claim 11, wherein the electrical connections are the same and wherein the battery backup unit comprises an electrical connector matching an electrical connector of the power supply unit.

13. The system of claim 11, wherein a power demand of the system is greater than a power output of the power supply unit.

14. The system of claim 13, wherein the at least two power supply units operate in a shared-power mode; and
wherein the power supply unit supplies a maximum amount of power output to the system and wherein the battery backup unit provides additional power to the system over the power output of the power supply unit to meet the power demand of the system.

15. The system of claim 11, wherein the at least two power supply units operate in a redundant-power mode; and
wherein the at least one battery backup unit in the redundant-power mode provides power to the system in an event of no power output by the power supply unit.

16. The system of claim 11, wherein the electrical connections are electrically connected to the backplane in parallel.

17. The system of claim 11, wherein the battery backup unit is charged from the system during a period of reduced power consumption by the system.

18. The system of claim 11, wherein the battery backup unit is not connected to an external power connection, wherein the power supply unit is connected to an external power connection.

19. A method, comprising:
detecting, at a system comprising a backplane and at least two power supply units electrically connected to the backplane, an increase in power consumption by the system, wherein at least one of the at least two power supply units comprises a power supply unit and wherein at least another of the at least two power supply units comprises a battery backup unit;
determining that a maximum power output of the power supply unit cannot fulfill the increase in power consumption by the system; and
receiving power output from the battery backup unit in addition to the power output of the power supply unit, wherein the power output from the battery backup unit and the power output of the power supply unit fulfill the increase in power consumption by the system.

20. The method of claim 19, wherein the at least two power supply units are electrically connected in parallel with each other.
